(19) United States
(12) Patent Application Publication
(10) Pub. No.: US 2011/0071831 A1
(43) Pub. Date: Mar. 24, 2011

(54) Method and System for Localizing and Authenticating a Person

(75) Inventors: Marta Garcia Gomar, Mostoles (Madrid) (ES); Marta Sanchez Asenjo, Mardrid (ES)

(73) Assignee: AGNITIO, S.L., Madrid (ES)

(21) Appl. No.: 12/736,761

(22) PCT Filed: May 9, 2008
(86) PCT No.: PCT/EP2008/003768

§ 371 Date: Nov. 4, 2010

(51) Int. Cl. G10L 17/00

(52) U.S. Cl. 704/246; 704/E17.001

(57) ABSTRACT

The present invention refers to a method for localizing a person comprising the steps carried out in a computing system (1): determining (20) the localization of a telecommunication means (3, 6, 8) or determining a telecommunication means (3, 6, 8) at a specific location; this can be implemented using ANI or calling number received and a database to look up address of a fixed telephone, for a cellular device, cell-ID or triangulation can be used; receiving (21) a voice utterance of a person by the telecommunications means; and verifying (22) the identity of that person based on the received voice utterance using biometric voice data (speech, speaker recognition). Further the invention relates to a corresponding system and computer readable medium.

The present invention refers to a method for localizing a person, to a system for localizing a person and to a computer readable medium corresponding to the method for localizing a person.

Localizing a particular person is an important issue in many cases. For example in working places it is of interest to assure that a certain person is at its working place. In other cases, it may be necessary to localize a person if the person has restrictions due to legal reasons for leaving a certain area or house.

In prior art systems, e.g. cards or transponders are used in order to localize a person since the person may subject the card to a reader device thereby localizing itself.

Such systems are subject to fraud since, indeed, only the localization of the card, but not of the person is assured and the card may be used by any other person.

The present invention refers to providing a method and a system which allows for an improved localization of a person which makes fraud more difficult or impossible.

Further it may be of interest to localize a person which is searched. Various telephone calls maybe intercepted in order to find a specific person. In this case the identity of the person the voice utterance of which is received is not claimed as in the case of a verification of an identity but the person is identified from its voice utterance.

This problem is solved with the method of claim 1, the system of claim 15 and the computer readable medium of claim 16.

Preferred embodiments are disclosed in the dependent claims.

In the method, a particular combination of certain information is used. Firstly, the localization of a specific telecommunication means is determined or, in other cases, a particular telecommunication means at a specific location is determined. Then or before a voice utterance of a person is received by this particular telecommunication means and the identity of that person is verified using biometric voice data and the received voice utterance. With this combination of information, it is made sure that an identified person is within acoustic reach of the telecommunication means, and hence, since the localization of the telecommunication means is known also the localization of the person is known.

A voice utterance from a person is received and it can then be verified that the identity of the person which is to be localized coincides with the identity of the person from which the voice utterance was received. This verification here is based on the received voice utterance and thereby allows the use of biometric voice data which individually characterizes each person.

The received voice utterance is used during verification not or not only based on the semantic content.

Characteristics of a persons individual voice are preferably taken into account. Such characteristics (biometric voice data) are dependent on the shape and size of a throat, mouth etc. They further may depend on personal ways of pronouncing letters or words or the timing of pronunciation of certain words.

Biometric voice data may be data extracted from a frequency analysis of a voice. From a voice utterance voice sequences of e.g. 20 or 30 ms may be Fourier-transformed and from the envelope thereof biometric voice data can be extracted. From a multiple of such Fourier-transformed voice sequences a statistical voice model can be generated, named Gaussian mixed model (GMM). However, any other biometric voice data that allow distinguishing one voice from another voice due to voice characteristics may be used.

Therefore, fraud in this case is made practically impossible since the voice of a person can hardly be falsified.

In the verification step, an assumed or previously determined or indicated identity is verified. The identity to be verified may be determined before determining a telecommunication means at a specific location. In this case the telecommunication means is determined corresponding to the person the identity of which is to be verified. The identity to be verified may be indicated by the person of which the voice utterance is received. This may be done via the same telecommunications means, which is used for transmitting the voice utterance. The identity to be verified may be spoken and transmitted by telephony, or the identity to be verified may be transmitted otherwise as numbers or letters typed into a device such as a telephone, etc. The identity to be verified may be given by a name, an identification number or any other alphanumeric identification (including a mixture or letters and numbers).

In case that in the method an identification is carried out the identity of the person of the voice utterance is not assumed to be known (not claimed) such that it could be verified. Instead a person of a voice utterance is identified based on the voice utterance. This maybe that case for intercepted telephone calls, which maybe (e.g. arbitrarily) intercepted at a certain telecommunications knot or in a certain region.

In this case the semantic content of the voice utterance is not known. Hence the biometric voice data may be given by a Gaussian Mixed Model being a model of the voice of the person which is searched for.

The determination of the localization of the telecommunications means may hence be done before, while or after identifying that person. For example the localization of the telecommunication means may be determined with a subsystem of the computing system while the computing system (or a subsystem) identifies the person.

In the step of identifying a person the biometric voice data of one person or of several persons may be used. In case of several persons it is preferred to have biometric voice data of a predetermined set of persons. During the identification one or none of the persons of the predetermined set are identified by the voice utterance

In a preferred embodiment, a landline telephone connection is used as the telecommunication means. Since landline telephones have a very specific location which is not easily changed, fraud becomes difficult. In case of a mobile telephone device, triangulation of the position of the mobile telephone is possible due to the cellular structure of the mobile phone system. In this triangulation the position is determined with respect to two or more base stations, the position of which are known such that the position of the mobile telephone can be determined. Therefore if a particular voice utterance is received by a mobile telephone, the position of which is triangulated, the localization of the person is determined.

Further, for Internet devices, an IP address is known which may have a specific relation to a location. If the voice utterance is received from an Internet device which is able to communicate with the computing system over the Internet, a localization of a person close to (within acoustic reach of) the Internet device, the localization of which is known, is determined.

In order to localize a telecommunication means, data which are stored in the computing system may be used. For example, the geophysical localization of a landline telephone may be stored in the computing system. The same applies for Internet devices which have an IP address.

A particular telecommunication means may be further adapted such that geophysical localization data are received from the telecommunication means. If the telecommunication means, for example, includes a geophysical locating function such as GPS or Galileo, then the localization of the telecommunication means is determined from data which are received from this telecommunication means.

Further, the data may be received from another service or device which is different from the computing system and the telecommunication means. In particular, for the triangulation of the mobile telephone localization data of the mobile telephone will be received from another service, namely a triangulation service of a mobile telephony operator.

In some embodiments, the method is initiated by the computing system. In particular, in cases where the localization of the person has to be checked from time to time, the method is preferably initiated by the computing system. The computing system may be e.g. provided with a clock and/or a timer which initiates the method at predefined times and/or in predefined time intervals, respectively. For example, for checking the presence of a person at a working place, such method may be initiated at the time at which the person is expected to be at the working place. Also the method may be initiated at random times by the computing system or at random times within predefined time intervals.

In other cases, the method may be initiated by the person. This applies for example to cases where the person is obliged to reveal his presence from time to time. This obviates, for example, the need of the person to show up at a certain office or place in order to demonstrate he did not leave a certain area.

In other cases the method is carried out upon the interception of a telephone call with which a voice utterance is received. As soon as the telecommunications connection is established the localization of the telecommunication means may be determined. As soon as with the established telecommunication connection a voice utterance is received by the telecommunication means, the person may be identified based on the voice utterance and the biometric voice data. The identification may be done before, while or after the determination of the localization of the telecommunication means.

In a preferred embodiment, the method comprises transmitting information to the person concerning a desired voice utterance. The information comprises, for example, a text which has, for example, text portions which may be words, numbers, letters or combinations thereof.

In this way, not only a localization, but also a time indication can be obtained. Since the text is transmitted during the localization method, and the person is supposed to repeat such text, it can be assured that the person was close to the telecommunication means at the time of carrying out the method for localization. Furthermore, this makes fraud even more difficult since, for example, predetermined voice utterance, which may be recorded for the purpose of fraud, will be of no help since the text is created dynamically during the method of localization.

It is a particular advantage if in the verifying step the expected voice utterance or, in other words, the transmitted information concerning the desired voice utterance is taken into account. This allows for improved ways of verifying the identify. By knowing what is said the verification can more specifically identify a coincidence of the voice utterance with a stored voice model. In the verification it is therefore expected, that the person repeats the text transmitted to him. In this case the statistical model (biometric voice data) used may be a Hidden Markow Model which takes into account transition probabilities from one Gaussian Mixed Model to another during the pronunciation of a word, text or sound, wherein each Gaussian Mixed Model refers to the pronunciation of one letter or individual sound of/within a word.

In the verification step the voice utterance may also be evaluated/processed not taking any information about an expected semantic content of the utterance into account. If for example the user is requested to provide some arbitrary text which he can make up himself the voice utterance is not related to any password, transmitted text or the like. Since the verification is preferably carried out based on biometric voice data the semantic content of the voice utterance may be of no importance and can be ignored.

In a further preferred embodiment, the text comprises random text portions. This assures that no prerecorded voice utterances can be used in order to be received at the computing system. Here it is in particular preferred to have random text portions which means that the text portions of the text are randomly selected and are not predefined. They may however, be randomly selected from a predefined set of text portions. The predefined set of text portions may comprise, for example, only numbers and/or letters and/or words.

In a further preferred embodiment, the text does not comprise more than three, four or five text portions. This is in case the text is rendered audibly to the person since with more text portions, it turns out to be difficult to repeat such memorized text portions.

In case the text is or can be rendered visible, it is preferable that the text comprises more than four to ten text portions. The longer the text, the more reliable is the carrying out the verification.

In case not more than three, four or five text portions are transmitted (at a time or before a corresponding voice utterance is received), it is preferred to repeat the transmission several times (preferably with different texts) in order to obtain more voice utterances.

Further, in the step of verifying the identity or in the identifying, a statistical voice model of the person can be used. A statistical voice model is preferably stored in the computing system. This statistical voice model may be a Gaussian Mixed Model and/or a Hidden Markow Model.

Once the identify of the person is verified, further information may be exchanged between the person and the computing system.

It is a particular advantage if the time of receipt of the voice utterance and/or the time of the determination of the localization of the telecommunication means is determined and preferably stored or transmitted. Thereby logs can be generated which demonstrate the localization of a person. Such time information may be used to assure compliance with certain rules imposed to the person, concerning when he should be at a certain place.

The voice utterance may further not be previously known. This is the case in intercepted telephone calls. Here as a biometric voice data a statistical model may be advantageously used, such as e.g. a Gaussian Mixed Model.

The corresponding system comprises a voice utterance receiving component, a localization determining component, and an identity verification or identification component.

The invention further refers to a computer readable medium and/or a data signal which comprise computer executable instructions which, when executed by a computer or computing system, perform a method as indicated above or below.

Further embodiments of the invention are disclosed in the following figures. These figures are intended only for illustrating particular examples but are not for limiting the scope of the invention. It is shown in:

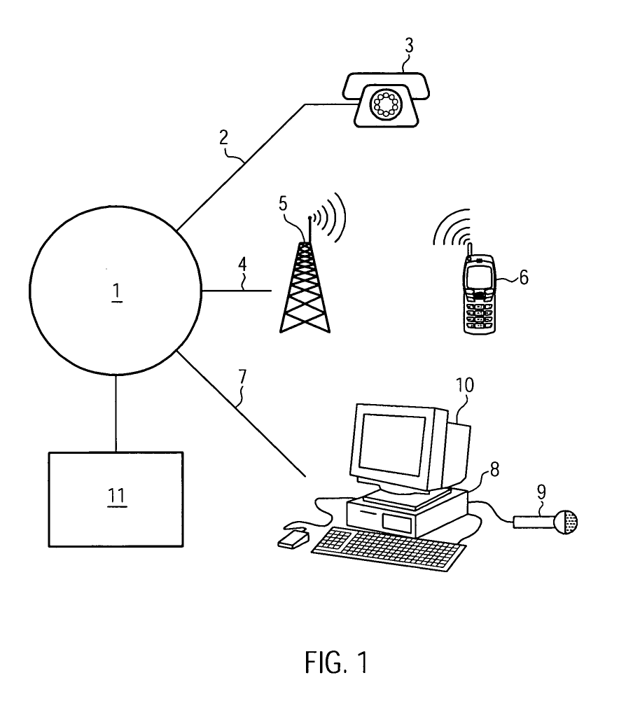

FIG. 1 different devices which may be used for localizing a person;

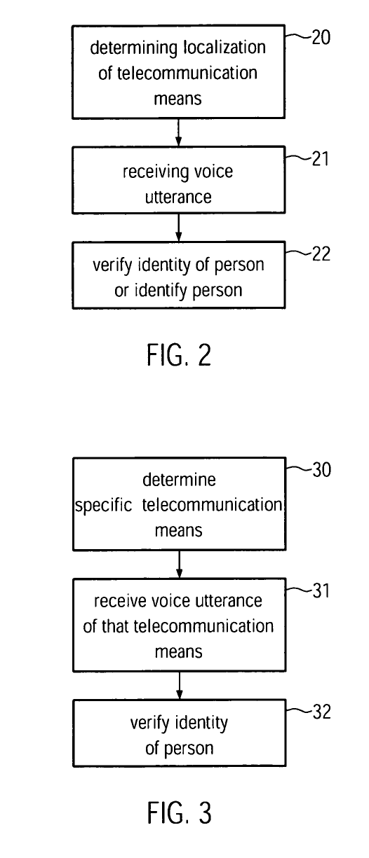

FIG. 2 steps of a method for localizing a person;

FIG. 3 steps of another method for localizing a person,

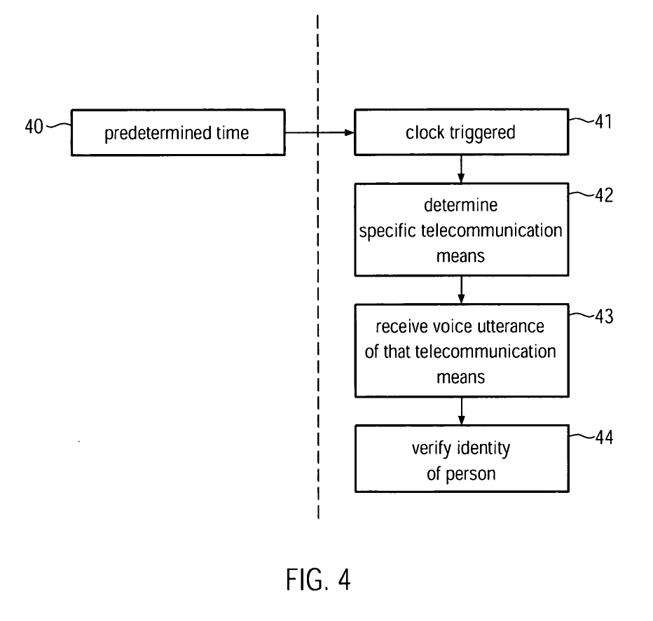

FIG. 4 steps of a further preferred embodiment for localizing a person;

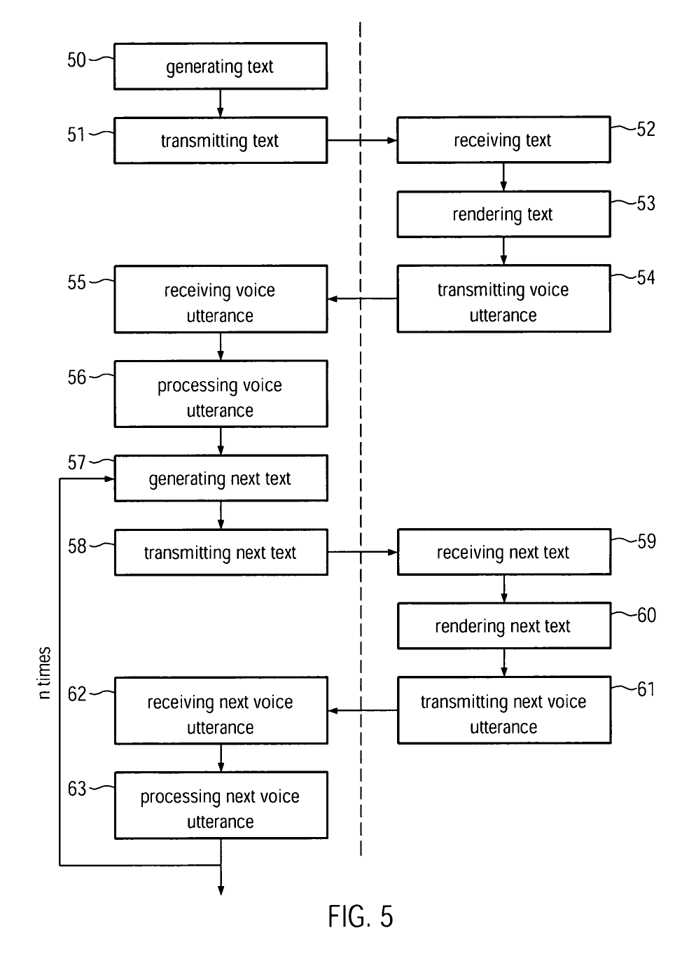

FIG. 5 steps of another preferred embodiment; and

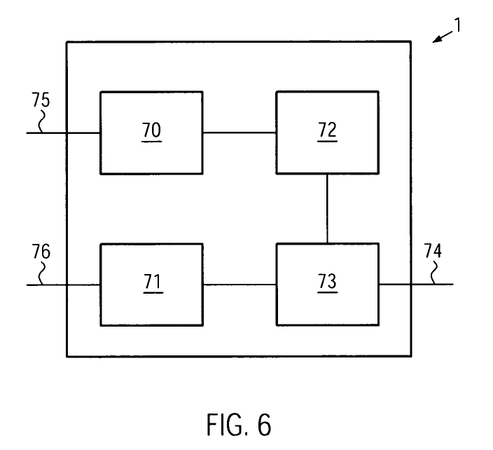

FIG. 6 a preferred embodiment of a system.

In FIG. 1, a computing system 1 is shown which may have a connection 2 to a landline telephone 3. Further, it may be connected by connection 4 to a mobile telephone communication system 5 which communicates with a mobile telephone 6.

The computing system may be further connected to an Internet device 8 which preferably has at least a microphone 9 and, furthermore, preferably has a screen (10).

Furthermore, the computing system 1 may be connected to other systems 11 which provide, for example, localization data of the telecommunication means.

In FIG. 2, in step 20, the localization of the telecommunication means is determined and in step 21, a voice utterance is received. In general, the determining step and the receiving of the voice utterance can be performed in any order. This means that the determination can be done before the voice utterance is received or afterwards or at the same time.

In step 22, the identity of the person is verified based on the received voice utterance and the biometric voice data. With these steps the person is localized in case that the verification results positively.

In general, the identity of the person that is to be verified can be determined from the particular telecommunication means or from a combination of a time information and a telecommunication means or information thereabout can be received by the telecommunication means. The person may, for example, indicate via the telecommunication means or any other telecommunication system a name, an identification number or any other information indicating his identity. This indication can then be verified with the voice utterance and the biometric voice data.

The localization of the telecommunication means may be determined, for example, by querying a database which provides the information relating the extension of the telecommunication means with a geographical position, e.g. in case of a landline telephone or an Internet device. The geographical (geophysical) position (localization) may be indicated in form of a postal address, an indication of a part of a building such as a room or a door or entrance, a particular street or in geographical meridian/latitude/altitude indications or any other suitable indication for indicating a position.

The localization may also be determined by triangulation of a mobile telephone device as explained above.

The localization of the telecommunication means may also determined from a telephone number received by a telecommunications means. Such numbers can be transmitted as meta data concerning a telephone connection. With such a number a database or a localization service can be used to obtain the localization information about the device.

Further in case that a person is identified this verification is not based on any other information than the voice utterance itself. Here a Gaussian Mixed Model may be used to identify a person.

In FIG. 3, a preferred example is shown wherein a specific telecommunication device is determined at a specific location. If, for example, the presence of a predetermined person at a particular machine or place or any other location shall be verified, then a suitable telecommunication means is determined in step 30. If, for example, at a specific location a landline telephone is installed, the telephone number of this landline telephone can be determined in step 30. This applies equally to the case of an Internet device having an IP address.

In step 31, the voice utterance is received via this telecommunication means. Then in step 32, the identity of a person is verified and thereby the person is localized.

The voice utterance in steps 21 and 31 may be most conveniently received by a telephone connection which transmits data in real time. The voice utterance may nevertheless also be received in a voice mail or a recorded voice data. Recorded utterances have the advantage that the sound quality is usually better than in real time data transmission since lost data packets maybe resend easily without loss of data as is common in telephone connections.

In FIG. 4, a further example of a preferred embodiment is shown wherein the method for localizing a person is triggered by the computing system. In the computing system, a predetermined time 40 is stored which causes a clock to be triggered such that the method for localizing a person is initiated. Steps 42-44 correspond to steps 30 to 32.

With help of FIG. 5 other preferred embodiments of the method are explained. The left side corresponds to the side of the computing system and the right side to the side of the person which is to be localized. In step 50, text is generated. This may be a text randomly composed of text portions, wherein each text portion is a letter, a number or a word. In step 51, this text is transmitted and this text is received in step 52 on the right side and rendered in step 53. The receiving and rendering may be done by the telecommunications means or any other device. The text may for example be transmitted by an Email, an SMS, instant messaging or the like. The text may also be rendered audible by the or another telecommunications means. In step 54 a voice utterance is transmitted which is received on the computing system side in step 55.

In the computing system a timer or a clock may be used to check a timely receipt of the voice utterance. For example a time limit may be set within which a voice utterance has to be received, after the text has been transmitted. This time limit may be for example 30 seconds, 1, 2 or 5 minutes. If the voice utterance is not received in time the method may start again in step 50 generating a new text. If the voice utterance is not received in time several times the method may be aborted and a human operator may be informed of the failure of the localization.

In step 56, the received voice utterance is processed. This processing can, for example, be the verifying step 22 or 32 of FIG. 2 or 3. The remaining steps are optional and refer to a preferred embodiment. The steps 50 to 56 therefore correspond to the steps 21 and 22 of FIG. 2 or steps 31 and 32 of FIG. 3. In step 56 wherein the verifying is performed the generated text of step 50 is preferably taken into account.

In the further preferred embodiment in step 57, the next text is generated which is transmitted in step 58 and received in step 59. This next text is rendered in step 60, the next voice utterance is transmitted in step 61 which is received in step 62. In step 63, the next voice utterance is processed which may be an additional verifying step. Steps 57 to 63 can be repeated n times, n being any number between, for example, 0 and 10. By generating different texts and receiving different voice utterances, the verification quality can be enhanced. This means that the probability of an erroneous verification is reduced.

The steps of steps 57 to 63, however, may also relate to any further information exchanged between the computing system on the left side and the person on the right hand side after a successful verification.

FIG. 6 shows a preferred embodiment of a system. Here a voice utterance receiving component 70 can receive a voice utterance via a telecommunications connection 75. Further a localization determining component 71 can determine the localization of a telecommunications means or determine a specific telecommunications means at a specific location. For this purpose additional information may be received by an optional connection 76 which may be a telecommunications connection for communicating for example with the service 11 of FIG. 1 and/or which may provide the connection to a database.

Further an identity verification or identification component 72 is provided which can verify the identity of the person of which the voice utterance was received or can identify a person of which the voice utterance was received. With those three components 70 to 72 a person can be localized. In FIG. 6 a further component 73 is shown which may further process the information obtained by the component 71 and 72. For example the information may be further transmitted via telecommunication means 74 to other computing systems.

For example in case that a person can not be localized successfully other ways for localizing a person may be initiated. Further other persons may be informed of the fact that a specific verification did not result positively.

1-16. (canceled)

17. A computer-implemented method for localizing a person, comprising the steps of:
(a) determining the localization of a telecommunication device or determining a telecommunication device at a specific location;
(b) receiving a voice utterance of a person by the telecommunications device; and
(c) verifying the identity of that person or identifying the person based on the received voice utterance using biometric voice data.

18. The method of claim 17, wherein the telecommunication means is a landline telephone, a mobile telephone or an internet device.

19. The method of claim 17, wherein the localization of the telecommunication means is determined with help of data which are:
(a) stored in the computing system; and/or
(b) received from the telecommunication means; and/or
(c) received from another service or device which is different from the computing system and the telecommunication means.

20. The method of claim 17, wherein the method is initiated by the computing system.

21. The method of claim 17, wherein the method is initiated by the person.

22. The method of claim 17, wherein further comprising the step of transmitting information to the person concerning the desired voice utterance which preferably comprises providing text having text portions such as words, numbers, letters or combinations thereof.

23. The method of claim 22, wherein the information to the person concerning a desired voice utterance is rendered such that a person can read or hear the text in order to speak the text for creating the voice utterance.

24. The method of claim 17, wherein in the step of verifying the identity or identifying a statistical voice model of the person is used wherein preferably the statistical voice model is stored in the computing system.

25. The method of claim 17, wherein the time of the receipt of the voice utterance and/or the time of the determination of the telecommunications means is determined and preferably stored or transmitted.

26. The method of claim 17, wherein the person to be localized is determined before receiving the voice utterance and/or before determining the localization of the telecommunications means or before determining a telecommunications means at a specific location.

27. The method of claim 17, wherein the voice utterance is not previously known and preferably a statistical model is used which is a Gaussian Mixed Model.

28. System for localizing a person comprising:
(a) a voice utterance receiving component for receiving a voice utterance of a person by a telecommunications means;
(b) a localization determining component for determining the localization of that telecommunication means or for determining a telecommunication means at a specific location; and
(c) an identity verification or identification component for verifying the identity of that person or identifying that person based on the received voice utterance using biometric voice data.
